(19) United States
(12) Patent Application Publication
(10) Pub. No.: US 2007/0007748 A1
(43) Pub. Date: Jan. 11, 2007

(54) Trailer hitch alignment and signaling device

(76) Inventor: Jimmy Glen Hancock, Tyler, TX (US)

Correspondence Address: Ronald B. Sefrna, P.O. Box 567, Tyler, TX, 75710, US

(21) Appl. No.: 11/481,192

(22) Filed: Jul. 5, 2006

Related U.S. Application Data
(60) Provisional application No. 60/696,462, filed on Jul. 5, 2005.

(51) Int. Cl. B60D 1/36

(52) U.S. Cl. 280/477

(57) ABSTRACT

A trailer hitch alignment and signaling device for guiding a tow vehicle with a trailer hitch ball into position for coupling a trailer with a trailer tongue extending outwardly from the body of the trailer and a coupler for connection to the hitch ball at the outer end of the tongue, includes a mounting bracket to be connected to the trailer tongue; a Y-shaped guide with a leg and two arms connected to the leg at a diverging angle, the guide pivotally connected to the mounting bracket and rotatable between a first position with the arms below and on either side of the coupler and a second position with the arms of the guide stowed between the mounting bracket and the trailer body; and a signaling assembly for signaling that the tow vehicle is in correct position for connecting the trailer coupler to the hitch ball.

### RELATED APPLICATION DATA

This application claims the benefits of U.S. Provisional Patent Application Ser. No. 60/696,462, filed Jul. 5, 2005, titled “Trailer Hitch Alignment And Signaling Device”.

### FIELD OF THE INVENTION

The present invention generally relates to devices for aligning a trailer hitch on a towing vehicle with the hitch coupling on a trailer, and in its preferred embodiments more specifically relates to a trailer mounted device for bringing the vehicle mounted hitch and the trailer mounted coupling into alignment, and for signaling to the operator of the vehicle that the proper vehicle position for coupling the trailer to the vehicle has been achieved.

### BACKGROUND

Trailers are widely utilized to serve a variety of purposes, both business and recreational. The fitting of a trailer hitch to a vehicle such as a pickup truck, car, or SUV to enable the vehicle to be coupled to a trailer is relatively easy and inexpensive. The type of vehicle mounted trailer hitch relevant to the present invention extends outwardly from the rear of the vehicle below the bumper or body, and includes an extension and a hitch ball mounted on the extension. Trailers to be towed by vehicles with this hitch type include a tongue that extends outwardly from the front of the trailer body, with a coupler at the forward end of the tongue to receive and connect to the ball of the vehicle hitch.

In order for the trailer coupler to be connected to the ball of the vehicle hitch, those components must be brought into proper orientation so the coupler can be lowered onto the ball and closed to make the connection. If the trailer is small and very light in weight the person making the connection can pick up the tongue and move the trailer to position the coupler over the ball, but most trailers are too large and heavy to be easily and safely moved in that manner. In that case it is necessary for the vehicle to be backed into position and stopped with the vehicle hitch ball directly below the trailer coupler. During the final stages of that operation neither the hitch ball nor the trailer coupler are directly visible to the driver of the vehicle. If a second person is available to stand outside the vehicle and direct the driver, backing the vehicle into the correct position can be accomplished relatively easily, but if a second person is not available, the driver typically must find the correct position by trial and error. The trial and error approach is not only time consuming and frustrating for the driver, it also involves a risk of backing the vehicle too far and damaging the vehicle, the trailer, or both.

Various alignment devices and aids have been devised in an attempt to address this problem, but none of the devices and aids known in the prior art have been fully successful. In one approach a mirror is mounted on the rear of the vehicle to allow the driver to see the vehicle hitch, and presumably the trailer coupling, in the mirror as the driver backs the vehicle toward the trailer. However, directing the mirror based on the image in such a mirror is not intuitive and requires the development of a degree of skill. Further, this approach is effective only if the particular vehicle equipped with the mirror is used as the tow vehicle.

In another approach an upright pole is temporarily attached to the vehicle hitch and another pole is mounted on the trailer tongue, so the driver of the vehicle can use the poles to gauge the position of the hitch ball relative to the trailer coupler while backing the vehicle toward the trailer. Although this approach does improve visibility, using the guides effectively requires practice, and it can still be difficult for most drivers to back the vehicle into the correct position without having to exit the vehicle to check position and perform final adjustments.

In still another approach a guide device is attached to the vehicle hitch structure, to guide and lift the trailer tongue and coupler over the hitch ball on the vehicle, and then allow the trailer coupler to drop onto the hitch ball. In some designs the guide is permanently mounted on the vehicle hitch structure, and in others it is removable. With the permanently mounted design the device is associated with a specific vehicle, and with the removable design the device must be available in or on each vehicle used for towing.

### SUMMARY OF THE INVENTION

The present invention provides an alignment device to be mounted on a trailer, rather than on the vehicle used to tow the trailer. With the device of the invention mounted on a trailer, any vehicle equipped with a trailer hitch can be readily aligned with the trailer for coupling the trailer to the vehicle. The device of the invention interacts with the hitch structure of an approaching vehicle to bring the trailer coupler into proper alignment even when the vehicle is backed toward the trailer with the hitch aimed to either side of the coupler.

The device of the invention includes a mounting bracket that attaches to the lower surface of a trailer hitch tongue that extends forward from the body of the trailer, between the coupler and the body of the trailer. A Y-shaped guide is pivotally connected to the mounting bracket near the outer end of the leg of the guide. The guide may be pivoted between a position with the arms of the guide below and on either side of the coupler, to guide the hitch extension and hitch ball on a tow vehicle into coupling position below the coupler, and a second position with the arms of the guide stowed between the mounting bracket and the body of the trailer. In the stowed position the guide is removed from possible interference with the coupling between the trailer and the tow vehicle.

The device of the invention also includes a sensor and indicator to signal the driver when the hitch ball is in the proper position below the trailer coupler for the coupler to be lowered directly onto the hitch ball. The signaling system of the invention includes a switch positioned between the arms of the guide near their intersection with the leg of the guide, a power source, and a signal light that can be mounted in any convenient visible location on the trailer.

The structure and features of the device of the invention will be described in detail below, with reference to the accompanying drawing figures.

### BRIEF DESCRIPTION OF THE DRAWINGS

FIG. 1 is a bottom plan view of the device of the invention, in place on a trailer tongue, with the guide component of the device in a first position for guiding a tow vehicle and the trailer into coupling position.

FIG. 2 is a bottom plan view of the device of the invention, in place on a trailer tongue, with the guide component of the device in a second, stowed position.

FIG. 3 is a side elevation view of the device of the invention, in place on a trailer tongue, with the guide component in the first position, as in FIG. 1.

FIG. 4 is a side elevation view of the device of the invention, in place on a trailer tongue, with the guide component in the stowed position, as in FIG. 2.

FIG. 5 is a top plan view of the guide component of the preferred embodiment of the device of the invention.

FIG. 6 is a bottom plan view of the mounting bracket component of the preferred embodiment of the device of the invention.

FIG. 7 is a side elevation view of the guide component of the preferred embodiment of the device of the invention.

FIG. 8 is a side elevation view of the mounting bracket of the preferred embodiment of the device of the invention.

FIG. 9 is a schematic diagram of the preferred embodiment of the electrical circuit for the signaling system of the device of the invention.

FIG. 10 is a side elevation view of an alternative embodiment of the device, with the guide in the first position for guiding a tow vehicle.

FIG. 11 is a side elevation view of the alternative embodiment of FIG. 10, with the guide in the second, stowed position.

### DESCRIPTION OF THE INVENTION

The device of the invention, generally designated by reference number 10, includes a Y-shaped guide 11 that is pivotally connected to a mounting bracket 12. The mounting bracket 12 is mounted on the tongue of a trailer with which the device is to be used, between the trailer hitch coupler and the body of the trailer. Guide 11 includes two arms 13 and 14 connected at one end to each other and to a base leg 15, and extending outwardly from that connection at an angle to each other. Mounting bracket 12 includes a mounting plate 16 that extends downwardly from the bottom of the trailer tongue and longitudinally parallel to the trailer tongue. Guide 11 is pivotally connected to mounting plate 16 by a pivot pin 17 that extends through apertures 18 and 19 in the mounting plate and in base leg 15 of guide 11, respectively.

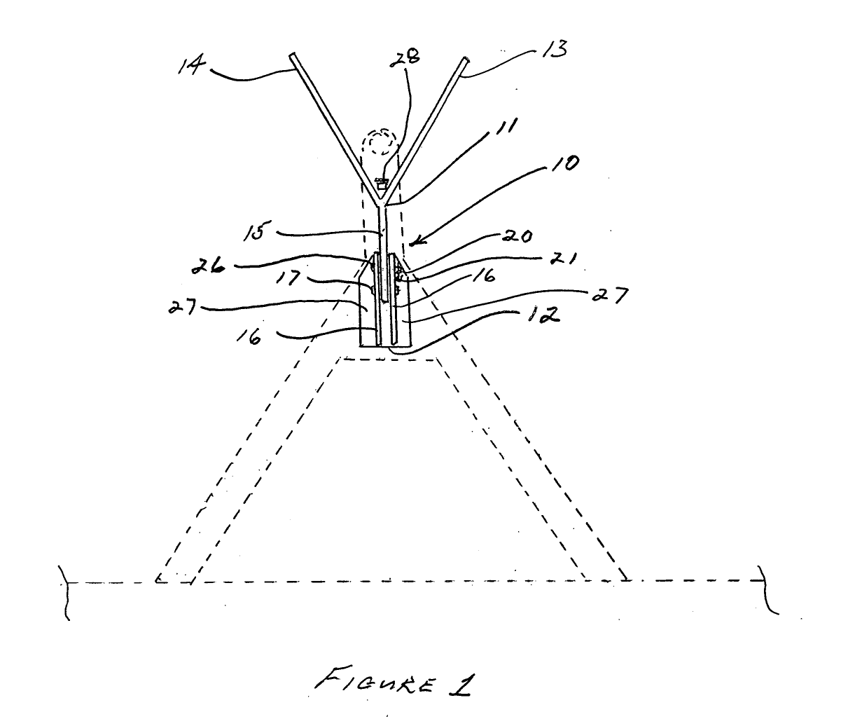

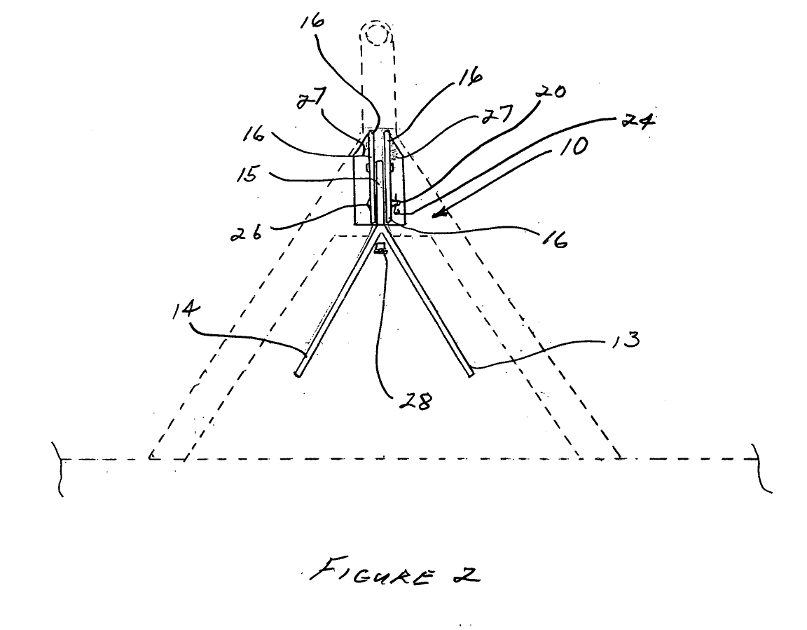

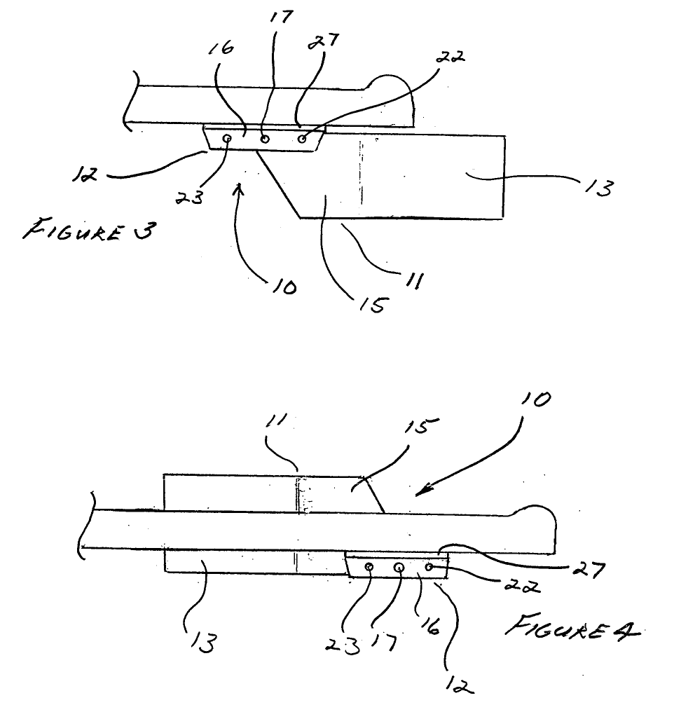

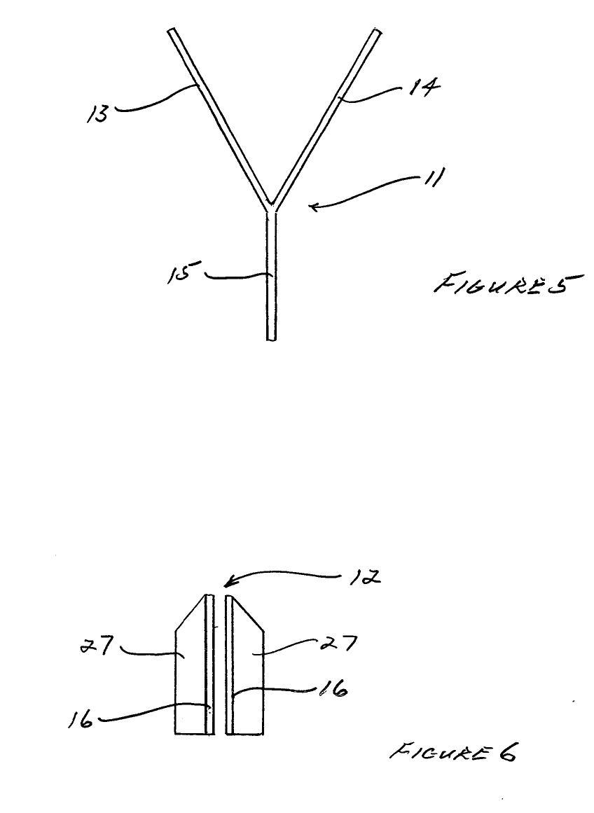

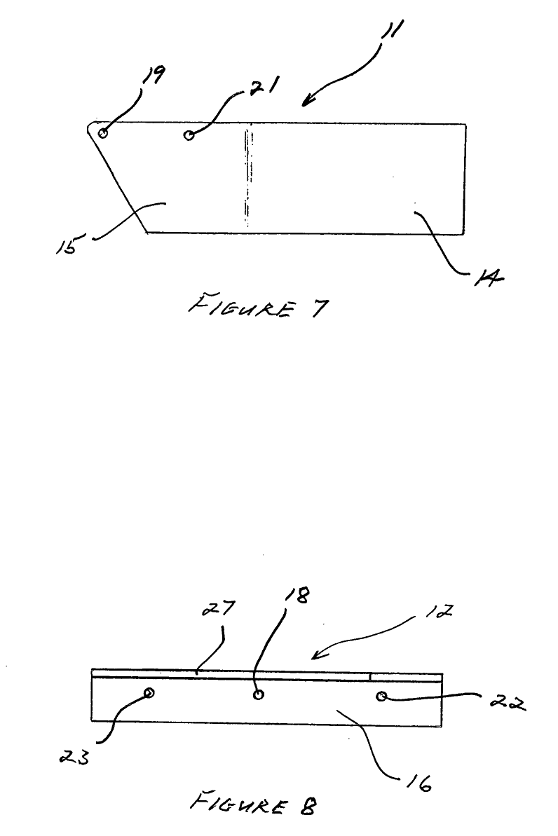

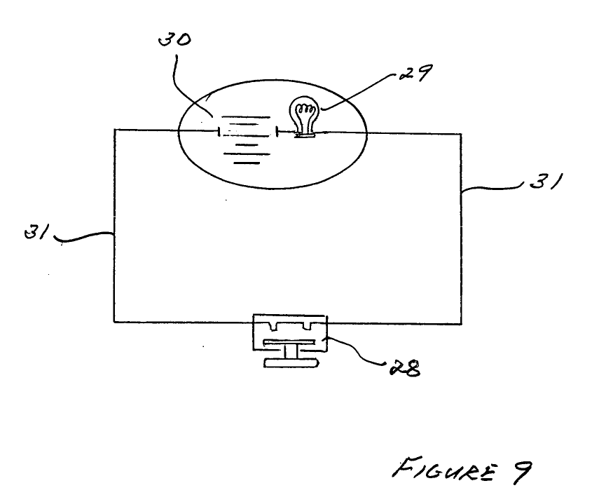

Guide 11 is moveable between a first, or coupling position, illustrated in FIG. 1, with guide 11 positioned with arms 13 and 14 on either side of and extending forward of the trailer coupler, and a second, or stowed position, illustrated in FIG. 2, with guide 11 rotated generally 180 degrees from the first position, such that arms 13 and 14 are positioned below and on either side of the trailer tongue and extend toward the trailer body. Guide 11 is retained in the first position by extending a retainer pin 20 through aperture 21 in base leg 15 of the guide and through a forward aperture 22 in mounting plate 16. Similarly, guide 11 is retained in the second, or stored, position by extending retainer pin 20 through aperture 21 in the base leg and a rear aperture 23 in mounting plate 16. Retaining pin 20 may be temporarily secured through the respective apertures by a cotter-type pin 24 that is removably inserted through an aperture 25 extending through pin 20 perpendicular to the longitudinal axis of the pin near one end. The opposite end of pin 20 preferably includes a head 26 of larger diameter than apertures 21, 22, and 23, to prevent head 26 from slipping through the apertures. The specific design of the means for retaining guide 11 in the first and second positions is not critical, and it is to be understood that other means may be used if desired within the scope of the invention.

In the preferred embodiment, arms 13 and 14 are single plates formed of steel, or other strong rigid material that will withstand the forces and stresses imposed upon the arms during the alignment procedure. Base leg 15 is also a single plate formed of steel or other suitable material. Arms 13 and 14, and base leg 15 may be individual components connected to each other by, e.g., welding, to form the Y-shaped guide 11, or one of the arms and the base leg may be a single plate that is bent at the point of connection of the other arm, and the other arm connected to the bent plate to form the Y-shaped guide. Arms 13 and 14 preferably extend from their intersection at an angle of about sixty degrees, but other angular relationships may be used. In the preferred embodiment the length of each of arms 13 and 14 from their connected ends to their outer ends is approximately eight inches, and the width, or height, of the arms is approximately four inches. The length of base leg 15 from its intersection with arms 13 and 14 to its outer end is preferably about six inches and the width is also approximately four inches through the majority of its length. In the illustrated embodiment the outer end of leg 15 is formed at an angle to eliminate a square corner and reduce the possibility of interference. In the preferred embodiment the thickness of the plates forming the arms and base leg is approximately one quarter inch. Although these dimensions are preferred, the invention is not limited to the use of any specific component dimensions, and other dimensions suitable for the intended purpose and positions of the components may be used within the scope of the invention.

Mounting bracket 12 includes a base 27, for connection of the mounting bracket to the trailer tongue, with at least one mounting plate 16 connected to and extending outwardly from and generally perpendicular to base 27. In the preferred embodiment mounting bracket 12 includes a pair of parallel mounting plates 16 with a space between them to receive leg 15 of guide 11. Base 27 is divided into two portions disposed side by side, with one of plates 16 extending from each portion of the base. In this preferred embodiment each portion of base 27 and the associated mounting plate is formed from a piece of approximately two inch by two inch steel angle, with one flat of the angle forming the base portion and the other, extending perpendicular to the base, forming mounting plate 16. Each portion of base 27 is connected to the trailer tongue by welding, or by bolts or other suitable means. The two pieces of angle used in the preferred embodiment are readily available at low cost, and this embodiment of the mounting bracket may be easily fabricated and attached. However, the construction of the mounting bracket is not limited to this particular structure. Base 27 may readily be formed as a single piece with the pair of mounting plates 16 connected to it by, e.g., welding.

The preferred embodiment of the device of the invention is particularly suited for use with a trailer tongue structure formed of two members extending from the trailer frame at a converging angle relative to each other, which intersect and are joined together forward of the trailer body. The trailer hitch coupler is joined to the two angled tongue members and extends forward from their intersection along the longitudinal axis of the trailer. A triangular reinforcing plate or member is typically connected between the two tongue members at their intersection to stabilize and strengthen the tongue structure. The mounting bracket 12 of the preferred embodiment is connected to, typically, the reinforcing plate or member of the trailer tongue with mounting plates 16 extending downward below the lower edge of the tongue. Guide 11 is disposed with leg 15 between mounting plates 16 and pivotally connected thereto by pivot pin 17, which extends through a pair of aligned apertures 18 in the mounting plates and through aperture 19 in leg 15 of the guide.

Guide 11 is positioned to align a tow vehicle with the trailer for connecting the trailer coupler to the hitch ball on the tow vehicle by rotating guide 11 around pivot pin 17 to bring arms 13 and 14 into position on either side of and extending below and forward of the trailer coupler. The guide is temporarily retained in that position by extending retainer pin 20 through aligned apertures 22 in mounting plates 16 and aperture 21 in leg 15 of the guide. Pin 24 may then be placed through the retainer pin to ensure that it remains in position through the apertures. The trailer coupler is raised to an elevation above the elevation of the hitch ball on the tow vehicle.

The tow vehicle is backed toward the trailer to bring the hitch ball into the general proximity of the coupler, aimed between the outer ends of arms 13 and 14 of guide 11. If the hitch ball is not aimed correctly, to move directly under the trailer coupler, the hitch ball and/or the extension from the rear of the vehicle on which it is mounted will impact against arm 13 or arm 14 in front of the trailer coupler. As the vehicle is backed toward the trailer the force exerted between the vehicle hitch structure and the arm of guide 11 as the vehicle hitch slides along the arm acts to move the trailer and shift the vehicle on its suspension to bring the hitch ball into the correct position below the trailer coupler. When the correct position is reached the vehicle is stopped and the driver may then exit the vehicle and lower the trailer tongue to bring the coupler onto the hitch ball. When the trailer coupler is secured to the vehicle hitch, retainer pin 20 is removed from apertures 21 and 22, and guide 11 is rotated around pivot pin 17 to bring arms 13 and 14 between the structural members of the trailer tongue and aperture 21 in leg 15 of the guide into alignment with apertures 23 in mounting plates 16. Retainer pin 20 is then inserted through those apertures and secured in place to retain guide 11 in the stowed orientation, between the tongue members and well away from the trailer hitch components.

The structure of guide 11 and mounting bracket 12 of the preferred embodiment provides strength, stability, and durability to withstand the forces imposed against the components of the device, and to effectively transfer those forces to the trailer so as to move the trailer during the alignment process.

A common problem encountered by the driver of a tow vehicle, especially when the driver is alone, during the coupling of a trailer to the vehicle is backing the vehicle too far toward the trailer, requiring the driver to readjust the position of the vehicle. Backing too far can also cause damage to the vehicle, the trailer, or both. The device of the invention addresses and overcomes this problem by providing a signaling system to give a clear indication to the driver that the hitch ball is directly under the trailer coupler in the proper position for connection.

In the preferred embodiment the signaling system of the device includes a switch 28, mounted between arms 13 and 14 of guide 11 near their intersection with leg 15, a signal light 29, a power source 30, and electrical wiring 31 to form the electrical circuit of the signaling system. It is preferred that power source 30 comprise one or more batteries, preferably mounted in the base of an enclosure for light 29, although the power source could be separated from the light and mounted in any desired location on the trailer. Signal light 29 is mounted on any convenient location on the trailer where it can be readily seen by the driver of a tow vehicle as the vehicle is backed toward the trailer.

In the preferred embodiment the electrical circuit for the signaling system is independent of the trailer structure. Switch 28 is preferably a spring loaded switch biased toward an open position until a lever or button 32 is depressed to close the switch contacts against the spring bias and complete the electrical circuit to activate signal light 29. When lever or button 32 is released the spring forces the electrical contacts to open, interrupting the circuit and extinguishing the signal light.

Switch 28 is located so that the switch lever or button 32 will be engaged and depressed by the hitch ball of the tow vehicle to activate signal light 29 when the hitch ball has reached the correct position beneath the trailer coupler for connection of the trailer to the vehicle. When the trailer coupler is lowered onto the hitch ball the switch is released and the electrical circuit is opened. It is preferred that the switch be resiliently mounted on guide 11, so that the switch is able to move in its resilient mounting in response to continued pressure against lever or button 32, so as to protect the switch against excessive force from the hitch ball. Alternatively, the switch may be disposed at the point between arms 13 and 14 where the hitch ball engages both arms and is prevented from further movement against the switch. In a further variation, a brace may be connected between arms 13 and 14 as a stop for the hitch ball, and the switch mounted behind the brace with the lever or button in front of the brace. If desired, the trailer frame may be used as, e.g., the negative leg of the electrical circuit, so long as there is electrical continuity between the point at which the switch is grounded to the frame and the power source and light are grounded.

The structure of the device of the invention is susceptible to a number of alternative embodiments in addition to those introduced above. In one alternative design the mounting bracket 12 is formed with a single mounting plate 16. Guide 11 is formed with a pair of legs 15, both connected to the guide at the intersection of arms 13 and 14, and extending parallel to each other with a space between them to receive mounting plate 16 between the legs 15.

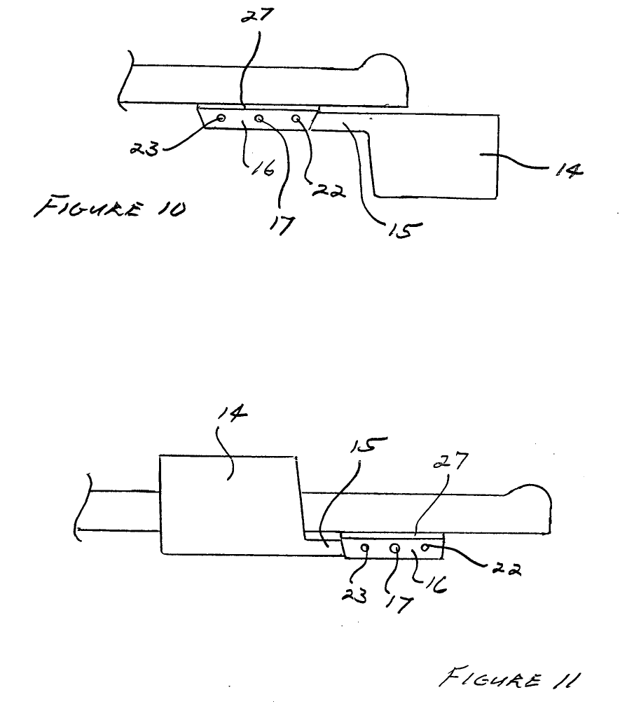

Alternative configurations for base 27 of the mounting bracket may also be used, especially to accommodate different trailer tongue structures. Some trailers are designed with a single tongue member extending outwardly from the trailer body, and the shape and size of base 27 may be varied from the preferred configuration to more conveniently and/or securely attach to such a trailer tongue structure. In an embodiment of the device for use with a single tongue member, the width of leg 15 of guide 11 can be reduced, as illustrated in FIGS. 10 and 11, to allow the guide to be rotated to a stowed position, with leg 15 lying along the lower surface of the tongue member and arms 13 and 14 of the device disposed on either side of and extending above the tongue.

The foregoing description of preferred and alternative embodiments of the device of the invention is intended to be illustrative and not limiting. Further variations and alternative embodiments may be devised within the scope of the invention as recited in the following claims.

1. A trailer hitch alignment and signaling device for connection to the tongue of a trailer between the body of the trailer and the hitch coupler connected to the outer end of the tongue, for guiding the trailer hitch ball mounted on a tow vehicle into position for connection of the trailer coupler to the hitch ball, comprising,
a mounting bracket having a base to be connected to the tongue of the trailer, and a mounting plate having a first edge, a second edge, a first end and a second end, said mounting plate connected at said first edge to said base and extending outwardly therefrom generally perpendicular to said base and downwardly from said base below the trailer tongue with said base connected to the tongue, said base including a pivot aperture extending through said mounting plate and disposed between said first and second edges and said first and second ends, a forward aperture extending through said mounting plate and disposed between said pivot aperture and said first end of said mounting plate, and a rear aperture extending through said mounting plate and disposed between said pivot aperture and said second end of said mounting plate;
a generally Y-shaped guide having a leg with a first end and a second end, a first arm with a first end and a second end, and a second arm with a first end and a second end, said first arm and said second arm connected at said first ends thereof to said second end of said leg with said arms extending outwardly from said second end of said leg at a diverging angle, said leg including a pivot pin aperture extending through said leg adjacent to said first end thereof, and a retainer pin aperture extending through said leg and disposed between said pivot pin aperture and said second end of said leg, said leg pivotally connected to said base by a pivot pin extending through said pivot aperture of said mounting plate of said base and said pivot pin aperture of said leg of said guide, such that said guide is rotatable between a first position with said retainer pin aperture of said leg of said guide aligned with said forward aperture of said mounting plate of said mounting bracket and with said arms of said guide disposed below and on either side of the trailer coupler, and a second position with said retainer pin aperture of said leg of said guide aligned with said rear aperture of said mounting plate of said mounting bracket; and
a signaling assembly including a switch means disposed between said arms of said guide, a signal means to be activated upon actuation of said switch means, an electrical power source for providing power to said signal means upon actuation of said switch means, and electrical conductor means for conducting electrical power from said power source to said signal means upon actuation of said switch means.
